(19) United States
(12) Patent Application Publication
(10) Pub. No.: US 2019/0278389 A1
(43) Pub. Date: Sep. 12, 2019

(54) Capacitive Touch Pen

(71) Applicant: JING MOLD ELECTRONICS TECHNOLOGY (SHENZHEN) CO., LTD., Shenzhen (CN)

(72) Inventor: Chinsung Yang, Shenzhen (CN)

(21) Appl. No.: 16/046,969

(22) Filed: Jul. 26, 2018

(30) Foreign Application Priority Data
Mar. 7, 2018 (CN) 201810187496.6

(51) Int. Cl. G06F 3/0354

(52) U.S. Cl. CPC G06F 3/03545

(57) ABSTRACT

A capacitive touch pen of the present invention is disclosed. The capacitive touch pen includes a body, a connection module provided at one end of the body, and an extension module detachably attached to the connection module. The capacitive touch pen achieves function expansion by providing an extension module electrically connected to the body, and achieves rapidly replacing different extension modules by providing an extension module detachable attached to the connection module, thereby achieving switching extended functions, having a simple structure, and effectively promoting functional diversity of the capacitive touch pen.

### FIELD OF THE INVENTION

The present invention relates to the field of touch technology, particularly to a capacitive touch pen.

### BACKGROUND OF THE INVENTION

With the development of information technology, electric devices such as portable mobile devices are more and more relevant to people's lives. This kind of portable mobile device can receive an input of a user, and execute a function expected by the user according to the input. As an input device capable of receiving a user's input, a touch device is widely used for having the advantages of small volume, light weight, and being easy to operate.

Touch devices are mainly divided into two types, including resistive touch devices and capacitive touch devices. Resistive touch devices have a low cost and are easy to manufacture, but can only support one finger operation. Capacitive touch devices have the advantages of good operability and supporting multi-finger function and so are favored by users. The capacitive touch devices become popular products of touch devices. A capacitive touch device comprises a capacitive touch screen. A capacitive touch screen can sense a change of capacitance caused by finger touching an orthogonal capacitive pattern distributed on the screen, thereby measuring the touch position and touch strength.

With capacitive touch devices being popular, capacitive touch pens to realize man-machine interaction instead of fingers are well developed. Capacitive touch pens are mainly divided into active and passive types. A passive capacitive touch pen uses a pen head instead of a finger to touch the screen to cause a change of capacitance, thereby achieving touch control, which has the disadvantages that the change of capacitance is very little, so that the pen head needs to be very thick. An active capacitive touch pen has a battery and a mainboard built therein, and can sense a drive signal of a touch screen. The drive signal is output after processed by the mainboard, thereby achieving touch sense. An active capacitive touch pen can be designed to have a very thin pen head, have a better product quality, and is more and more favored by consumers.

In a conventional active capacitive touch pen, the mainboard and the battery are both provided in a shell of the capacitive touch pen. Meanwhile, the surface of the shell of the capacitive touch pen is also provided with various function modules electrically connected to the battery and/or the mainboard, such as a charge port electrically connected to the battery for charging the battery, a laser module electrically connected to the battery to be supplied with the energy in the battery, and an electronic eraser electrically connected to both the battery and the mainboard. All these function modules are integrally formed with the capacitive touch pen and so can not be replaced once being settled, which adversely affects the product function diversity. Meanwhile, all function modules are provided on the shell, so that the structure complexity of a capacitive touch pen is increased, which results in inconvenience for designing the structure of a capacitive touch pen.

### SUMMARY OF THE INVENTION

An object of the present invention is to provide a capacitive touch pen, which has a simple structure, and effectively promotes functional diversity of a capacitive touch pen.

To achieve the above object, a capacitive touch pen of the present invention includes a body, a connection module provided at one end of the body, and an extension module detachably attached to the connection module.

The body includes a shell, a battery module provided in the shell, a pen head provided at one end of the shell, and a circuit board connected to the pen head and the battery module respectively.

The connection module is mounted to the other end of the shell.

The extension module includes a seat, and a function module mounted to the seat. The seat is detachably attached to the connection module. The function module is electrically connected to the body to achieve the function of the function module.

The capacitive touch pen of the present invention achieves function expansion by providing an extension module electrically connected to the body, and achieves rapidly replacing different extension modules by providing an extension module detachably attached to the connection module, thereby achieving switching extended functions, having a simple structure, and effectively promoting functional diversity of the capacitive touch pen.

### BRIEF DESCRIPTION OF THE DRAWINGS

The characteristic and the technical solution of the present invention are best understood from the following detailed description with reference to the accompanying figures, but the figures are only for reference and explaining, not to limit the scope of the invention.

In the figures:

FIG. 1 is a perspective view of a capacitive touch pen in accordance with the first embodiment of the present invention;

FIG. 2 is a partial exploded view of FIG. 1 showing a connection module and an extension module being disconnected;

FIG. 3 is an exploded view of FIG. 1;

FIG. 4 is a partial section view of FIG. 1 showing one end of the capacitive touch pen provided with the extension module;

FIG. 5 is a perspective view of a capacitive touch pen in accordance with the second embodiment of the present invention;

FIG. 6 is a partial exploded view of FIG. 5 showing a connection module and an extension module being disconnected;

FIG. 7 is an exploded view of FIG. 5;

FIG. 8 is a partial section view of FIG. 5 showing one end of the capacitive touch pen provided with the extension module;

FIG. 9 is a perspective view of a capacitive touch pen in accordance with the third embodiment of the present invention;

FIG. 10 is a partial exploded view of FIG. 9 showing a connection module and an extension module being disconnected;

FIG. 11 is an exploded view of FIG. 9;

FIG. 12 is a partial section view of FIG. 9 showing one end of the capacitive touch pen provided with the extension module.

### DESCRIPTION OF THE PREFERRED EMBODIMENTS

To further set forth the technical solution adopted by the present invention and the effects thereof, the present invention is described detailedly with reference to the following preferred embodiments and the accompanying figures.

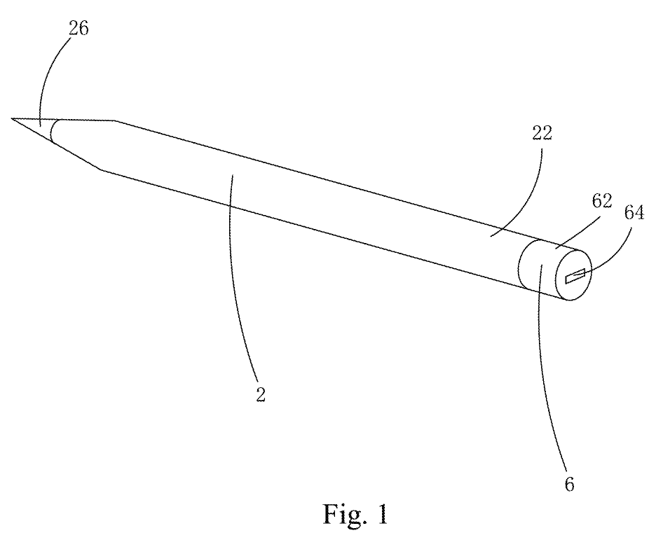

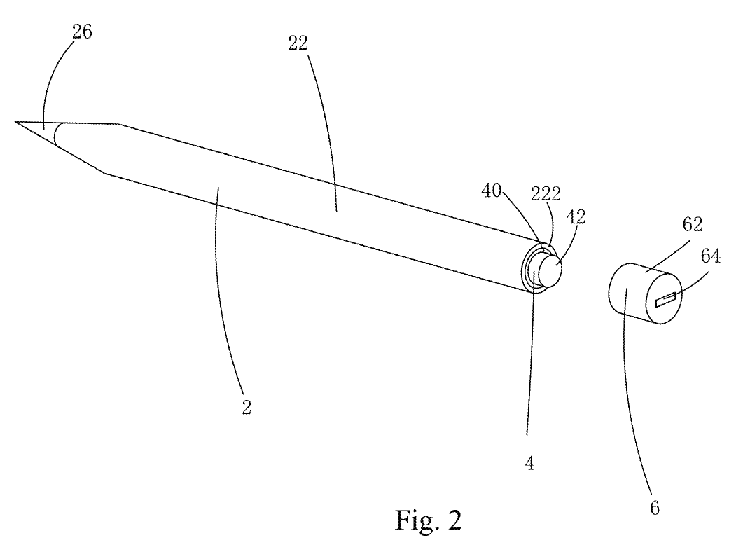

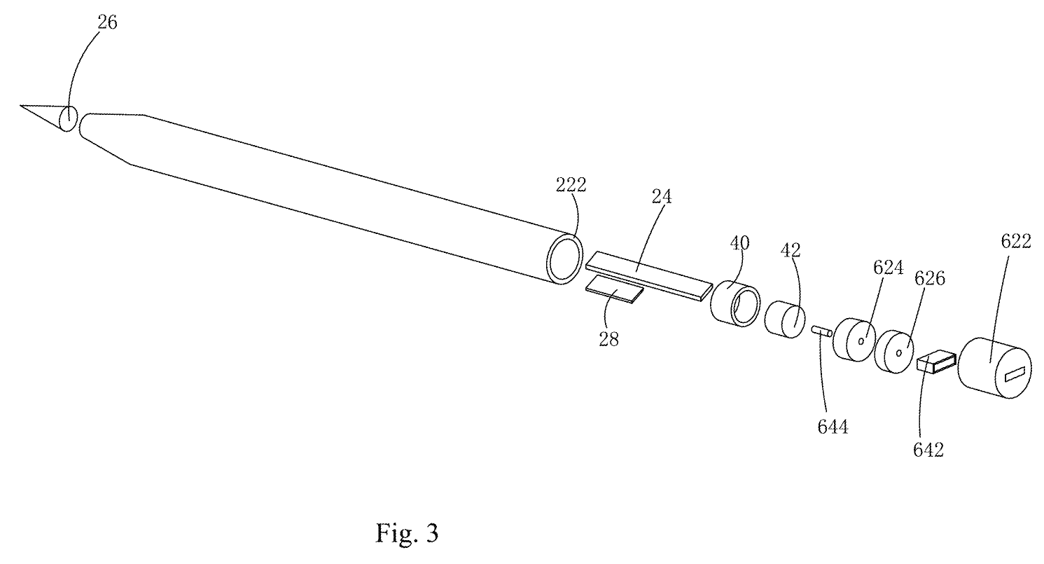

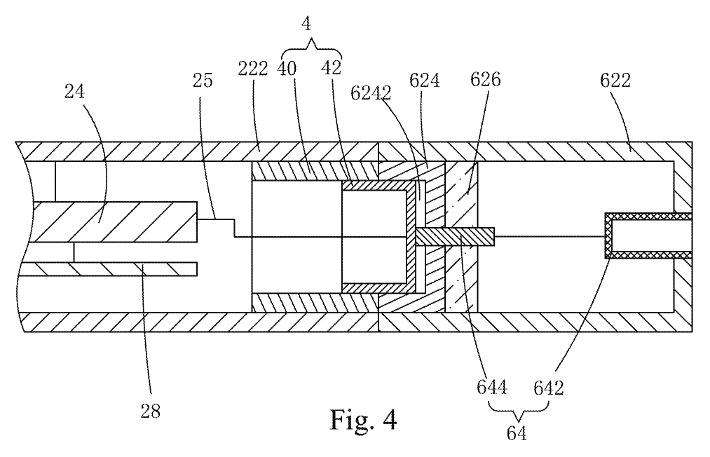

Referring to FIGS. 1-4, a capacitive touch pen in accordance with the first embodiment of the present invention includes a body 2, a connection module 4 provided at one end of the body 2, and an extension module 6 detachably attached to the connection module 4.

The body 2 includes a shell 22, a battery module 24 provided in the shell 22, a pen head 26 provided at one end of the shell 22 away from the connection module 4, and a circuit board 28 connected with the pen head 26 and the battery module 24 respectively. In this embodiment, the battery module 24 is a rechargeable battery. The connection module 4 is attached to the other end of the shell 22 away from the pen head 26.

The shell 22 includes a conductive tube 222. The tube 222 is electrically connected to the battery module 24.

The connection module 4 is fixedly connected to the inner side of the tube 222, and is exposed to one end of the tube 222. The connection module 4 is electrically connected to the battery module 24.

The extension module 6 includes a seat 62, and a function module 64 mounted to the seat 62. The seat 62 includes a conductive cover 622, and a first mounting bracket 624 mounted inside the cover 622 and located at one end of the cover 622. The function module 64 is electrically connected to the cover 622. The first mounting bracket 624 is insulating. The first mounting bracket 624 is provided with a groove 6242 to receive the connection module 4. The seat 62 is detachably attached to the connection module 4. The function module 64 is electrically connected to the connection module 4. The cover 622 is electrically connected to the tube 222.

The connection module 4 includes a second mounting bracket 40 mounted inside the tube 222 and located at one end of the tube 222, and a conductive cap 42 mounted to the second mounting bracket 40. The cap 42 is exposed to one end of the tube 222 provided with the second mounting bracket 40. The second mounting bracket 40 is insulating. The cap 42 is electrically connected to the battery module 24 via a first wire 25. The groove 6242 receives the cap 42. The function module 64 is electrically connected to the cap 42. The second mounting bracket 40 is located at the other end of the tube 222 away from the pen head 26.

The seat 62 can be connected to the connection module 4 via a mechanical connection, such as an elastic fastening or a threaded connection, or via a magnetic connection. The magnetic connection is adopted in this embodiment. Specifically, the material of the cap 42 is a magnetic metal. A magnetic component 626 is provided at one side of the first mounting bracket 624 away from the connection module 4. The material of the magnetic component 626 is a permanent magnet. The seat 62 is magnetically attached to the connection module 4 by the magnetic force between the magnetic component 626 and the cap 42.

The function module 64 can be achieved by adopting the conventional technology, to provide the corresponding function. In this embodiment, the function module 64 includes a charge port 642, and a first connector 644 electrically connected to the charge port 642. The charge port 642 is electrically connected to the cover 622. The first connector 644 is mounted to the first mounting bracket 624. The first connector 644 is exposed to the bottom surface of the groove 6242 to be electrically connected to the cap 42, and meanwhile the tube 222 is also electrically connected to the cover 622, whereby the battery module 24 can be charged via the charge port 642. The charge port 642 can be a conventional charge port, such as a Type-C port or a micro USB port. The first connector 644 is a pogo pin connector.

The charge port 642 is exposed to one end of the cover 622 away from the connection module 4, so as to be convenient for a user to charge.

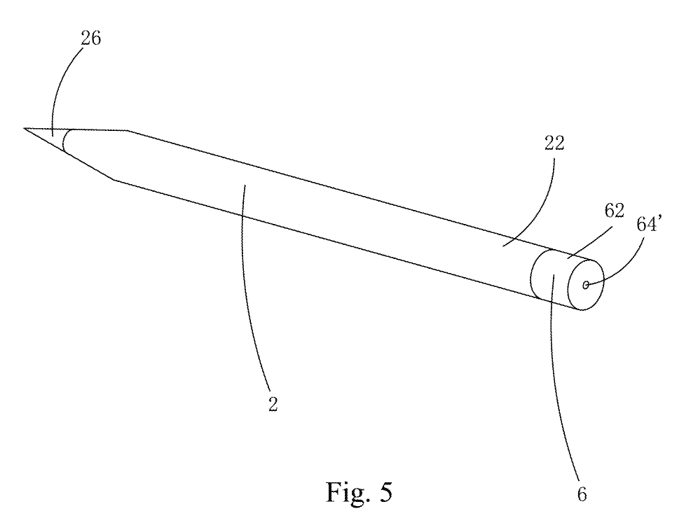

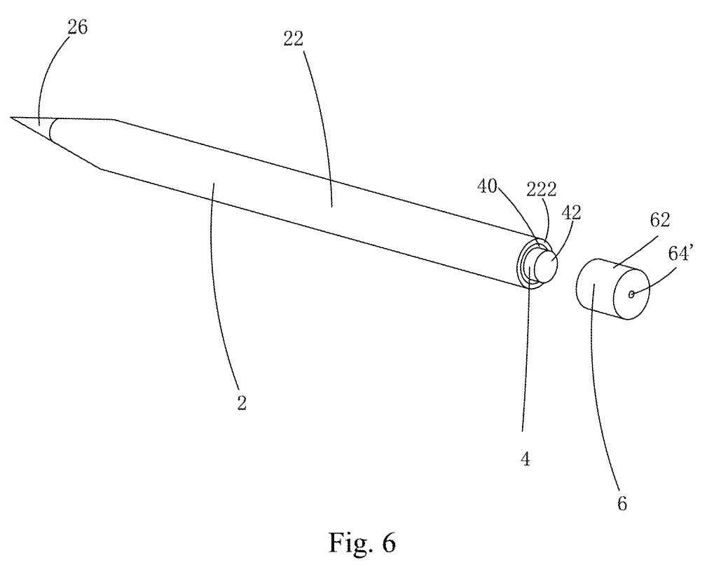

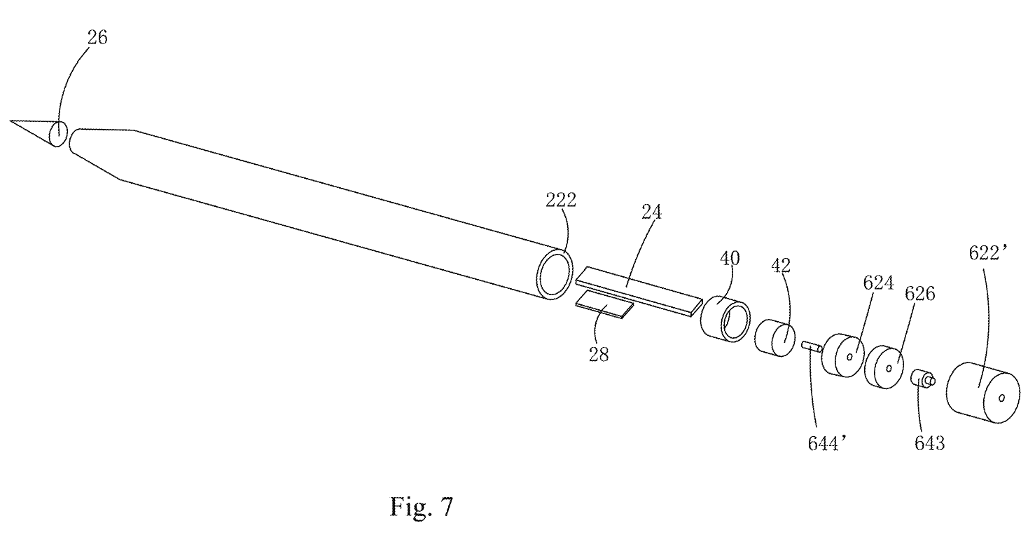

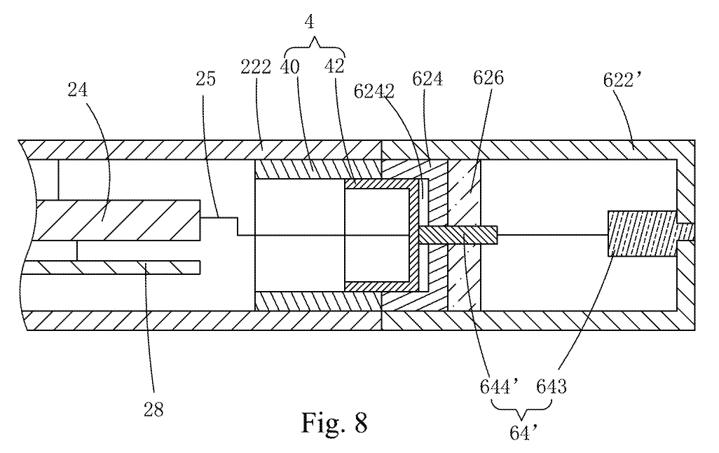

Referring to FIGS. 5-8, a capacitive touch pen in accordance with the second embodiment of the present invention is shown. The difference between the capacitive touch pens in accordance with the second embodiment and the first embodiment of the present invention is described as follows. A function module 64′ of the capacitive touch pen in accordance with the second embodiment of the present invention includes a laser module 643 and a first connector 644′ electrically connected to the laser module 643. The laser module 643 is electrically connected to a cover 622′. The first connector 644′ is mounted to the first mounting bracket 624. The first connector 644′ is exposed to the bottom surface of the groove 6242 to be electrically connected to the cap 42, and meanwhile the tube 222 is also electrically connected to the cover 622′. The battery module 24 is used to supply power to the laser module 643 to emit a laser light for indicating. Thus the capacitive touch pen of the present invention has the function of a laser pen.

The laser module 643 is exposed to one end of the cover 622′ away from the connection module 4, so as to be convenient for a user to use the laser module 643 of the capacitive touch pen of the present invention to send out a laser light.

The other structures of the capacitive touch pen in accordance with the second embodiment of the present invention are similar to those described in the first embodiment, and will be no more described herein.

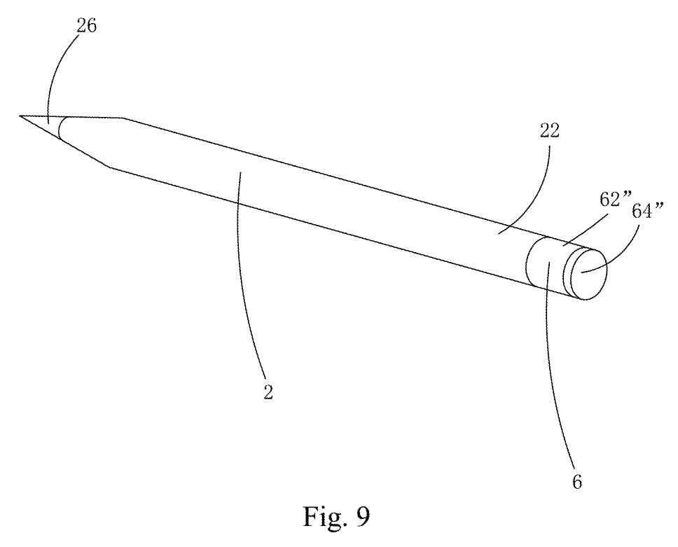

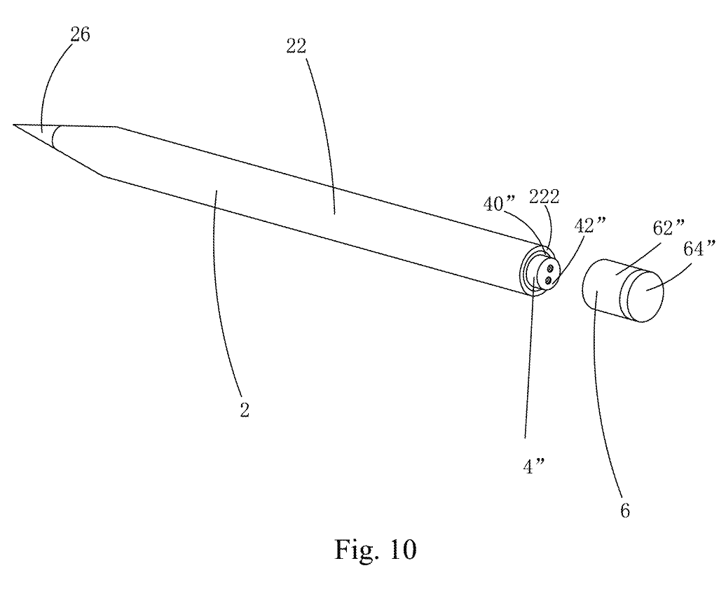

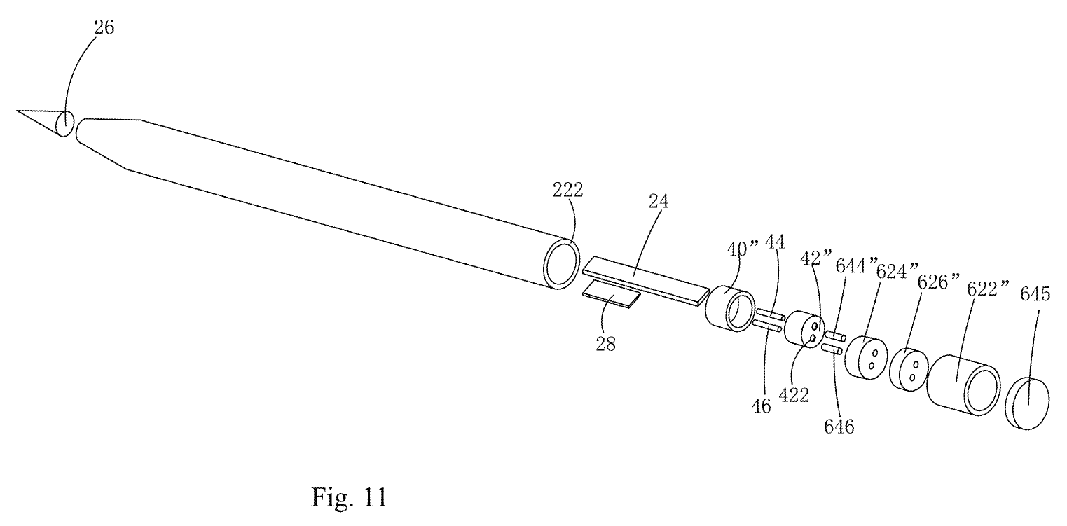

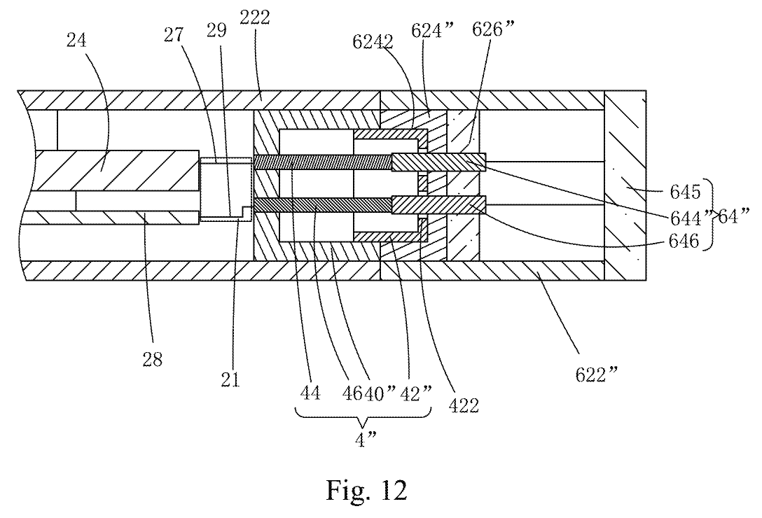

Referring to FIGS. 9-12, a capacitive touch pen in accordance with the third embodiment of the present invention is shown. The difference between the capacitive touch pens in accordance with the third embodiment and the first embodiment of the present invention is described as follows. A connection module 4″ of the capacitive touch pen in accordance with the third embodiment of the present invention includes a second mounting bracket 40″ mounted inside the tube 222 and located at one end of the tube 222, a first terminal 44, a second terminal 46, and a cap 42″ mounted to the second mounting bracket 40″. The first terminal 44 and the second terminal 46 are mounted to the second mounting bracket 40″. The cap 42″ is exposed to one end of the tube 222 provided with the second mounting bracket 40″. The groove 6242 receives the cap 42″. The cap 42″ is defined with apertures 422 corresponding to the first terminal 44 and the second terminal 46.

The first terminal 44 is electrically connected to the battery module 24 via a second wire 27, and the second terminal 46 is electrically connected to the circuit board 28 via a third wire 29. The second mounting bracket 40″ is insulating.

A seat 62″ is connected to the connection module 4″ by a magnetic connection. A magnetic component 626″ is provided at one side of a first mounting bracket 624″ away from the connection module 4″. The seat 62″ is magnetically attached to the connection module 4″ by the magnetic force between the magnetic component 626″ and the cap 42″. The material of the magnetic component 626″ is a permanent magnet, and the material of the cap 42″ is a magnetic metal.

A function module 64″ includes an electronic eraser 645, a first connector 644″ electrically connected to the electronic eraser 645, and a second connector 646 electrically connected to the electronic eraser 645. The electronic eraser 645 is electrically connected to the cover 622″. The first connector 644″ and the second connector 646 are both mounted to the first mounting bracket 624″. The first connector 644″ is exposed to the bottom surface of the groove 6242 through the aperture 422 to be electrically connected to the first terminal 44. The second connector 646 is exposed to the bottom surface of the groove 6242 through the aperture 422 to be electrically connected to the second terminal 46. The second connector 646 is also a pogo pin connector.

The battery module 24 is supplied with power to the electronic eraser 645, and the circuit board 28 is used to send signals to the electronic eraser 645, so that the function of the electronic eraser 645 erasing display content on a display panel is achieved.

The electronic eraser 645 is exposed to one end of the cover 622″ away from the connection module 4″, so as to be convenient for a user to use the electronic eraser 645 of the capacitive touch pen of the present invention to erase.

The second wire 27 and the third wire 29 are both provided at an FPC (flexible Printed Circuit) 21 contained in the tube 222.

The other structures of the capacitive touch pen in accordance with the third embodiment of the present invention are similar to those described in the first embodiment, and will be no more described herein.

It should be understood that, in the first and second embodiments of the present invention, the connection module 4 can also be configured to have a cap 42, and a first terminal electrically connected to the battery module 24. The cap 42 is defined with an aperture to expose the first terminal. At the same time, the cap 42 is not electrically connected to the battery module 24, and merely used as a structure for magnetically attaching. The first connector 644 is electrically connected to the first terminal, so that the electric power can be transmitted between the battery module 24 and the function module 64 via the connection route of the first connector 644 and the first terminal.

It should be understood that, in the third embodiment of the present invention, the connection module 4″ can also be configured to have a cap 42″ mounted to the second mounting bracket 40″ and electrically connected to the battery module 24, and a second terminal 46 mounted to the second mounting bracket 40″ and electrically connected to the circuit board 28. The cap 42″ is defined with an aperture 422 to expose the second terminal 46. The first connector 644″ is electrically connected to the cap 42″, and the second terminal 46 is electrically connected to the second connector 646. The signal can be transmitted between the circuit board 28 and the function module 64″ via the connection route of the second terminal 46 and the second connector 646. The electric power can be transmitted between the battery module 24 and the function module 64″ via the connection route of the cap 42″ and the first connector 644″.

It should be noted that, in the capacitive touch pen of the present invention, one end of the body is provided with a connection module, and an extension module is detachable attached to the connection module. The connection module can include a second mounting bracket and a cap directly electrically connected to a battery module. The connection module can also include a second mounting bracket, a cap, and first and second terminals respectively electrically connected to a battery module and a circuit board. The extension module includes a seat, and a function module mounted to the seat. The seat is detachably attached to the connection module. A cover is electrically connected to a tube, the battery module is electrically connected to the tube, and the function module is electrically connected to the cover. To make a first connector of the function module to be electrically connected to the cap, the function module is electrically connected to the battery module. Or to make a first connector and a second connector of the function module to be respectively electrically connected to the first terminal and the second terminal, the function module is electrically connected to both the battery module and the circuit board. Thus, the function module can get electric power from the battery module or charge the battery module, and the circuit board can transmit signals to the function module. Since the seat is detachably attached to the connection module, the capacitive touch pen of the present invention can be easily replaced with the extension module. Therefore, the capacitive touch pen can have various functions by replacing extension modules with various function modules to be attached to the connection module. Comparing with a conventional capacitive touch pen in which the function module is fixedly provided on the shell of the capacitive touch pen, the capacitive touch pen of the present invention has a simple structure, and can effectively promote functional diversity of the capacitive touch pen.

In summary, the capacitive touch pen of the present invention achieves function expansion by providing an extension module electrically connected to the body, and achieves rapidly replacing different extension modules by providing an extension module being detachably attached to the connection module, thereby achieving switching extended functions, having a simple structure, and effectively promoting functional diversity of the capacitive touch pen.

Although the present invention has been described in detail with above said embodiments, but it is not to limit the scope of the invention. So, all the modifications and changes according to the characteristic and spirit of the present invention, are involved in the protected scope of the invention.

What is claimed is:

1. A capacitive touch pen comprising a body, a connection module provided at one end of the body, and an extension module detachably attached to the connection module;
the body comprising a shell, a battery module provided in the shell, a pen head provided at one end of the shell, and a circuit board connected to the pen head and the battery module respectively;
the connection module being mounted to the other end of the shell;
the extension module comprising a seat, and a function module mounted to the seat; the seat being detachably attached to the connection module; the function module being electrically connected to the body to achieve the function of the function module.

2. The capacitive touch pen of claim 1, wherein the shell comprises a conductive tube; the tube is electrically connected to the battery module;
the connection module is fixed inside the tube, and is exposed to one end of the tube; the connection module is electrically connected to the battery module;
the seat comprises a conductive cover, and a first mounting bracket mounted in the cover and located at one end of the cover; the function module is electrically connected to the cover; the first mounting bracket is insulating and is defined with a groove to receive the connection module; the function module is electrically connected to the connection module; the cover is electrically connected to the tube.

3. The capacitive touch pen of claim 2, wherein the connection module comprises a second mounting bracket mounted in the tube and located at one end of the tube, and a conductive cap mounted to the second mounting bracket; the second mounting bracket is insulating; the cap is exposed to one end of the tube provided with the second mounting bracket; the cap is electrically connected to the battery module via a first wire; the groove receives the cap; the function module is electrically connected to the cap.

4. The capacitive touch pen of claim 3, wherein the seat is connected to the connection module by a magnetic connection; the material of the cap is a magnetic metal; a magnetic component is provided at one side of the first mounting bracket away from the connection module, and the material of the magnetic component is a permanent magnet; the seat is magnetically attached to the connection module by the magnetic force between the magnetic component and the cap.

5. The capacitive touch pen of claim 3, wherein the function module comprises a charge port, and a first connector electrically connected to the charge port; the charge port is electrically connected to the cover; the first connector is mounted to the first mounting bracket; the first connector is exposed to the bottom surface of the groove to be electrically connected to the cap;
the charge port is exposed to one end of the cover away from the connection module.

6. The capacitive touch pen of claim 3, wherein the function module comprises a laser module, and a first connector electrically connected to the laser module; the laser module is electrically connected to the cover; the first connector is mounted to the first mounting bracket; the first connector is exposed to the bottom surface of the groove to be electrically connected to the cap;
the laser module is exposed to one end of the cover away from the connection module.

7. The capacitive touch pen of claim 2, wherein the connection module comprises a second mounting bracket mounted in the tube and located at one end of the tube, a first terminal, a second terminal, and a cap mounted to the second mounting bracket; the second mounting bracket is insulating; the first terminal and the second terminal are mounted to the second mounting bracket; the cap is exposed to one end of the tube provided with the second mounting bracket; the groove receives the cap; the cap is provided with apertures corresponding to the first terminal and the second terminal;
the first terminal is electrically connected to the battery module via a second wire, and the second terminal is electrically connected to the circuit board via a third wire;
the function module comprises an electronic eraser, a first connector electrically connected to the electronic eraser, and a second connector electrically connected to the electronic eraser; the electronic eraser is electrically connected to the cover; the first connector and the second connector are both mounted to the first mounting bracket; the first connector is exposed to the bottom surface of the groove through the aperture to be electrically connected to the first terminal; the second connector is exposed to the bottom surface of the groove through the aperture to be electrically connected to the second terminal;
the electronic eraser is exposed to one end of the cover away from the connection module.

8. The capacitive touch pen of claim 7, wherein the seat is connected to the connection module by a magnetic connection; a magnetic component is provided at one side of the first mounting bracket away from the connection module; the seat is magnetically attached to the connection module by the magnetic force between the magnetic component and the cap.

9. The capacitive touch pen of claim 8, wherein the material of the magnetic component is a permanent magnet, and the material of the cap is a magnetic metal.

10. The capacitive touch pen of claim 7, wherein the second wire and the third wire are both provided at an FPC contained in the tube.
